(19) United States
(12) Patent Application Publication
(10) Pub. No.: US 2025/0056644 A1
(43) Pub. Date: Feb. 13, 2025

(54) BLUETOOTH CONNECTION METHOD AND DEVICE

(71) Applicant: LG ELECTRONICS INC., Seoul (KR)

(72) Inventors: Kyoungtae YOO, Seoul (KR); Yoonseok CHOI, Seoul (KR); Sekeun LIM, Seoul (KR)

(73) Assignee: LG ELECTRONICS INC., Seoul (KR)

(21) Appl. No.: 18/717,547

(22) PCT Filed: Dec. 9, 2021
(86) PCT No.: PCT/KR2021/018604

§ 371 Date: Jun. 7, 2024

(51) Int. Cl. H04W 76/19; H04W 24/02; H04W 24/08; H04W 76/15

(52) U.S. Cl. CPC H04W 76/19; H04W 24/02; H04W 24/08; H04W 76/15

(57) ABSTRACT

A Bluetooth connection device according to embodiments comprises: a reception unit which receives multiple audio signals on the basis of multiple Bluetooth links; and a processor for controlling the multiple links. The processor may: monitor reconnections of the multiple links on the basis of reconnection time and the number of reconnections in response to link losses of the multiple links; update information about the number of connections to the multiple links; and advertise the updated information about the number of connections. A Bluetooth connection method according to embodiments comprises the steps of: receiving multiple audio signals on the basis of multiple Bluetooth links; and controlling the multiple links. The controlling step may comprise the steps of: monitoring reconnections of the multiple links on the basis of reconnection time and the number of reconnections in response to link losses of the multiple links; updating information about the number of connections to the multiple links; and advertising the updated information about the number of connections.

### TECHNICAL FIELD

Embodiments relate to a Bluetooth connection method and device.

### BACKGROUND ART

A Bluetooth mode allows multiple connections between Bluetooth devices, for data transmission and reception. When a dual mode is provided, there is a need for a process of monitoring reconnections to multiple links, upon occurrence of link loss or range-out for two or more multiple links. A method of efficiently notifying a reconnection state and a final result during a reconnection attempt of a system that controls reconnection is yet to be specified.

### DISCLOSURE

### Technical Problem

Embodiments provide a Bluetooth connection method and device for efficiently controlling a Bluetooth multi-connection mode. Embodiments provide a reconnection and monitoring method that prevents a connection error for a device and its adjacent device, when a problem occurs in a multi-connection mode.

However, the scope of the disclosure is not limited to the above-described technical objects, and may be extended to other technical objects as inferred by those skilled in the art based on the entirety of the disclosure.

### Technical Solution

A Bluetooth connection device according to embodiments may include a receiver receiving multiple audio signals based on multiple links for Bluetooth, and a processor controlling the multiple links. The processor may be configured to, in response to link loss of the multiple links, monitor reconnection of the multiple links based on a reconnection time and a reconnection count, update information about the number of connections to the multiple links, and advertise the updated information about the number of connections. A Bluetooth connection method according to embodiments may include receiving multiple audio signals based on multiple links for Bluetooth, and controlling the multiple links. The controlling may include, in response to link loss of the multiple links, monitoring reconnection of the multiple links based on a reconnection time and a reconnection count, updating information about the number of connections to the multiple links, and advertising the updated information about the number of connections.

### Advantageous Effects

In embodiments, therefore, a reconnection progress state/reconnection final failure may be monitored in an application at a higher layer of a Bluetooth device system, in spite of occurrence of single-link/multi-link loss in one or multiple Bluetooth connections. While the system is reconnecting, the number of connected devices may be maintained. As this information is shared with other devices through BLE Advertising, the other devices may avoid making new connections during the reconnection.

### BRIEF DESCRIPTION OF THE DRAWINGS

The accompanying drawings, which are included to provide a further understanding of embodiments, illustrate embodiments of the disclosure together with the description of the embodiments. For a better understanding of various embodiments described below, reference should be made to the following description of the embodiments in conjunction with the following drawings, in which like reference numerals refer to corresponding parts throughout the drawings.

FIG. 1, FIG. 2, FIG. 3, and FIG. 4 illustrate a Bluetooth connection device according to embodiments.

FIG. 5 illustrates the structure of a Bluetooth connection device according to embodiments.

FIG. 6 illustrates a Bluetooth connection method according to embodiments.

FIG. 7 illustrates a Bluetooth connection method according to embodiments.

FIG. 8 illustrates a central device for a Bluetooth connection device according to embodiments.

FIG. 9 illustrates link loss of multiple connections according to embodiments.

FIG. 10 illustrates single-link loss according to embodiments.

FIG. 11 illustrates multiple connections according to embodiments.

FIG. 12 illustrates multiple connections according to embodiments.

FIG. 13 illustrates a Bluetooth connection device according to embodiments.

### BEST MODE

Preferred embodiments will be described in detail, examples of which are shown in the attached drawings. The detailed following description given with reference to the accompanying drawings is intended to describe preferred embodiments rather than showing only embodiments that may be implemented according to the embodiments. The following detailed description includes details to provide a thorough understanding of the embodiments. However, it will be apparent to those skilled in the art that the embodiments may be practiced without these details.

Most of the terms used in the embodiments are selected from common ones widely used in the field, but some terms are arbitrarily selected by the applicant and their meanings are described in detail in the following description as necessary. Accordingly, the embodiments should be understood based on the intended meanings of the terms rather than their mere names or meanings.

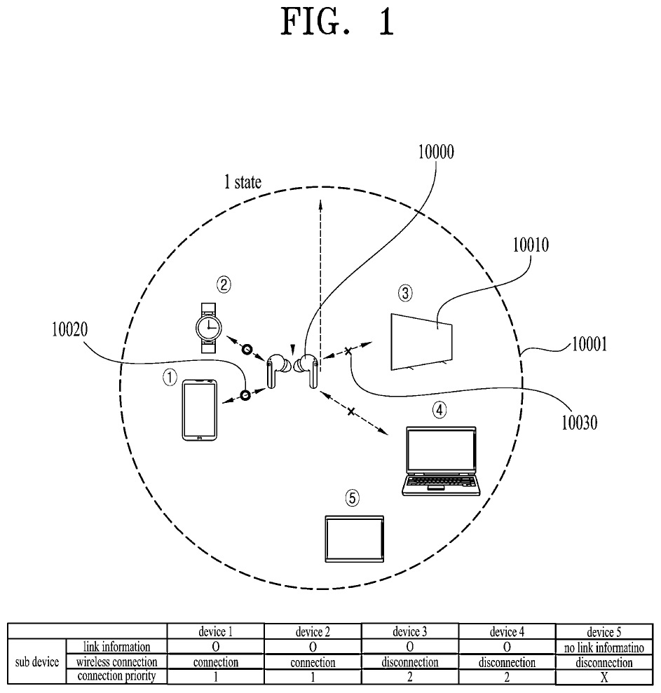

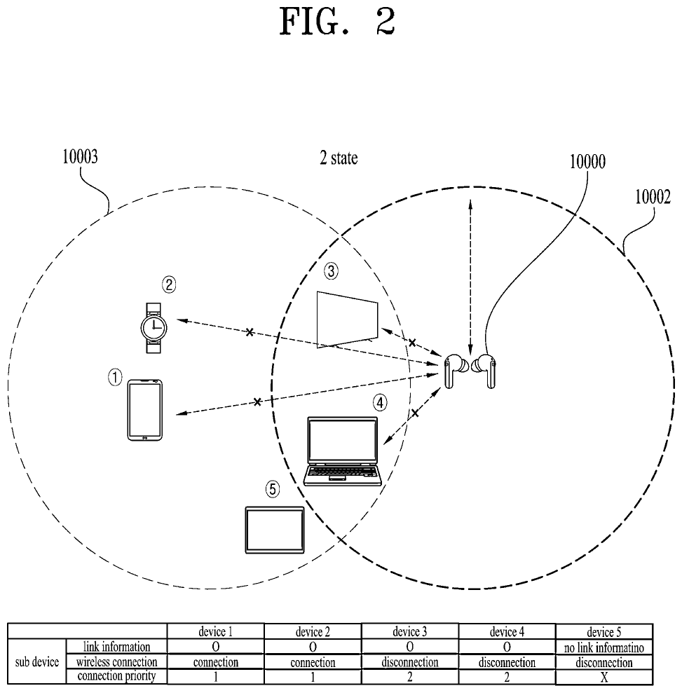

FIGS. 1, 2, 3, and 4 illustrate a Bluetooth connection device according to embodiments.

A Bluetooth connection method and device according to embodiments relate to a scheme of enhancing monitoring of reconnections of multiple links to which link loss occurs between various Bluetooth devices, and sharing connection state information. FIGS. 1 to 4 illustrate examples in which a Bluetooth connection device according to embodiments is connected to an adjacent device based on Bluetooth.

A Bluetooth connection device 10000 according to embodiments may be an earphone (earbud) and/or a headset. The Bluetooth connection device 10000 according to embodiments may perform a Bluetooth connection method according to embodiments. The Bluetooth connection device 10000 according to embodiments may be referred to as a slave. The Bluetooth connection device 10000 according to embodiments may be referred to as a peripheral.

Referring to FIG. 1, the Bluetooth device (an earbud or a headset) 10000 corresponding to the Bluetooth connection method and device according to embodiments may be connected to a mobile phone, a smart watch, a TV, a tablet PC, and/or a laptop 10010 based on a Bluetooth network. The Bluetooth connection device according to embodiments may be multi-connected to at least two devices 10010 (10020). The mobile phone and/or the laptop 10010 may be referred to as a master. The mobile phone and/or the laptop 10010 may be referred to as a central. FIG. 1 illustrates a case in which a Bluetooth connection device is multi-linked to multiple devices according to embodiments. The Bluetooth connection device 10000 according to embodiments may be connected based on the Bluetooth network. The network according to embodiments may have a specific connectable range.

For example, the Bluetooth connection device 10000 according to embodiments may be multi-connected to adjacent devices, and connections may not be established for some links. The Bluetooth connection device 10000 according to embodiments may have a specific connection range (or area) 10001. Devices connectable to the Bluetooth connection device according to embodiments or devices corresponding to the Bluetooth connection device may be included in the connectable range 10001. Sub-devices such as a mobile phone, a smart watch, a TV, a tablet PC, and/or a laptop may be referred to as a first device, a second device, a third device, and so on. The first device and the second device may include link information for Bluetooth connection. The link information may include information required for Bluetooth-based connection. Specifically, first to fourth devices may include link information, and a fifth device may not include link information. The fifth device without link information may not be connected to the Bluetooth network. The first to fourth devices with link information may or may not be connected to links based on their connection priorities. For example, when the first device and the second device have higher priorities than the third device and the fourth device, and two devices are connectable to links, the first device and the second device may be connected to the links, whereas the third device and the fourth device may be disconnected from the links.

FIGS. 1 to 4 illustrate examples of network-based multi-link loss according to embodiments. For example, when the Bluetooth connection device 10000 according to embodiments moves out of the connectable range or an error occurs in a connected link, link loss may occur.

For example, the Bluetooth connection device 10000 may be a device corresponding to a user-desired connection, and have a higher priority in a multi-link network. Upon occurrence of link loss, an adjacent device 10040 of the multi-link network may intervene. Since the adjacent device 10040 is not a device corresponding to the user-desired connection, a method of efficiently controlling it is required.

Link loss 10030 may occur between the Bluetooth connection device and multiple connected devices (e.g., the mobile phone and the laptop) 10010 according to embodiments.

In FIG. 2, link connections may be established between devices according to the link range of the Bluetooth connection device 10000 according to embodiments. The Bluetooth connection device 10000 may have a connectable link range 10002 with a specific distance. When the first device and the second device are in a range 10003 in which it is difficult for them to be linked to the Bluetooth connection device 10000, the first device and the second device may be disconnected from the device 10000 due to their locations in the distant area 10003 even though they have link information and high link priorities. For example, when the Bluetooth connection device 10000 linked to the first device and the second device as illustrated in FIG. 1 moves out of the link area 10003 to another area 10002 as illustrated in FIG. 2, the first to fourth devices may attempt to connect to the device 10000. When the first device and the second device attempt to reconnect, and the third and fourth devices located within the range attempt new connections, the Bluetooth connection device 10000 may select a high-priority device and link based on connection priority information illustrated in FIG. 2. Since the connection priorities of the first and second devices are higher than those of the third and fourth devices, the device 1000 may attempt to reconnect to the first and second devices. Link loss and reconnection attempts between adjacent devices may be processed for a specific time. The specific time may vary depending on settings. For example, embodiments may control reconnection (connection) between a link-lost device and a new adjacent device for 5 minutes after link loss occurs.

FIG. 3 illustrates a case in which the device 10000 linked in FIG. 1 moves out of the link range as illustrated in FIG. 2 and then returns to the linkable range. The first device and the second device may attempt to connect to the device 10000. The third and fourth devices have relatively low priorities and thus their reconnections are rejected. The fifth device does not have link information, and thus may be linked.

FIG. 4 illustrates an example in which the Bluetooth connection device 10000 is linked to a new device based on an update of priority information. Following the examples of FIGS. 1 to 3, the device 10000 may move out of the range where the first device and the second device are linked, and wait for a specific time in a disconnected state. When the specific time elapses according to embodiments, the device 10000 may update the priority information. For example, the connection priorities of the first device and the second device may be decreased, and the connection priorities of the third device and the fourth device located within the link area may be increased. That is, the Bluetooth connection device 10000 according to embodiments may receive signals for links from the third device and the fourth device. The device 10000 may establish multiple links with the devices based on the updated information.

The Bluetooth connection method and device according to embodiments may monitor reconnection for each link loss and perform Bluetooth advertising (BLE advertising) on adjacent devices, while remaining connected until a final connection failure. A nearby third device receiving Bluetooth advertising data (BLE advertising data) other than the devices attempting reconnection may know corresponding connection state information and thus determine whether to attempt a connection.

For example, when Bluetooth devices, for example, two or more Bluetooth devices are multi-connected and range-out occurs for two connections, a method is required to simultaneously monitor reconnections between the multiple devices.

Embodiments need to allow a slave to monitor reconnections of two connections after simultaneous range-out of the slave for the two connections, and to provide information based on which a nearby third-party device attempting to connect to a master during a reconnection attempt of the slave out of the range determines whether the connection is appropriate.

There is no reconnection process in the case where after one peripheral (an earbud or a headset) is multi-connected to two centrals and then link loss occurs to the two multi-connections.

2. Since information about the number of connectable devices is not included in advertising data broadcast by the peripheral, nearby paired centrals may attempt to connect to the peripheral which is to reconnect to the existing connections.

Embodiments may monitor during reconnection between one peripheral (slave) and two connectable centrals (masters), caused by link loss, and accordingly control connections of devices other than the two centrals to be reconnected.

There is a need for a method of, upon occurrence of link loss, knowing only the disconnection and notifying a remaining reconnection attempt state and whether a final reconnection is failed by a system including a higher-layer application, a lower-layer host, and a controller of a peripheral/slave Bluetooth device to which up to at least two links are connectable.

In other words, while the peripheral/slave is connected to centrals (masters), for example, master a and master b, respectively, the application of the peripheral/slave needs to receive an event related to simultaneous occurrence of link loss of A and B from the lower-layer system, and identify information about a connection attempt in progress and/or a final reconnection failure.

While the system of the Bluetooth connection device according to embodiments attempts to reconnect to centrals (masters) A and B, the application of the Bluetooth connection device according to embodiments transmits BLE advertising data including connection state information with information indicating no connection to adjacent devices based on BLE. A third central receiving the BLE advertising data may incorrectly determine that the peripheral (slave) is connectable and display a connectable state to a user or attempt to connect. To address this technical problem, embodiments may provide a reconnection monitoring process, when link loss occurs.

The application BLE-advertises information indicating a 2-connected state (meaning that no additional connection is possible) to adjacent devices until a final connection failure through a monitoring logic of the application of the Bluetooth connection device according to embodiments. A nearby third device receiving the BLE advertising data, other than the devices attempting to reconnect, may know connection state information about the peripheral (slave) and thus determine whether to connect (the third device recognizes that the peripheral is in the 2-connected state and thus does not attempt to connect)

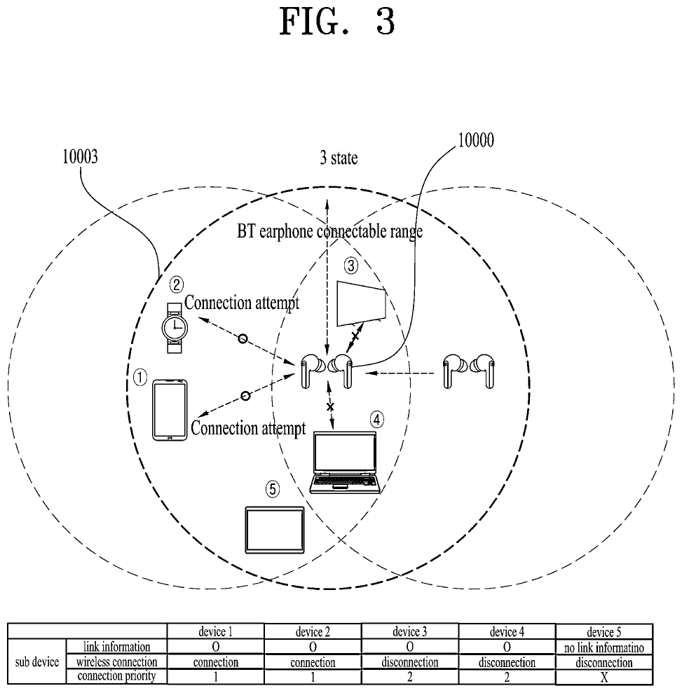

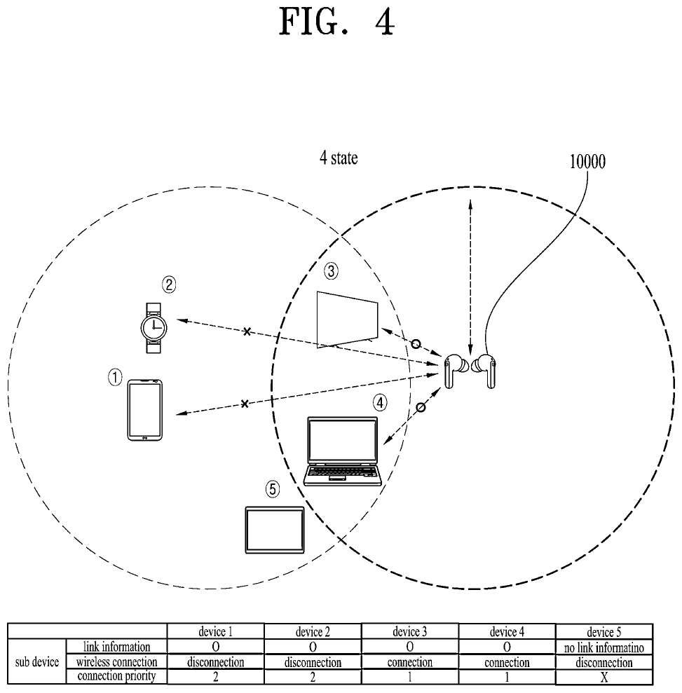

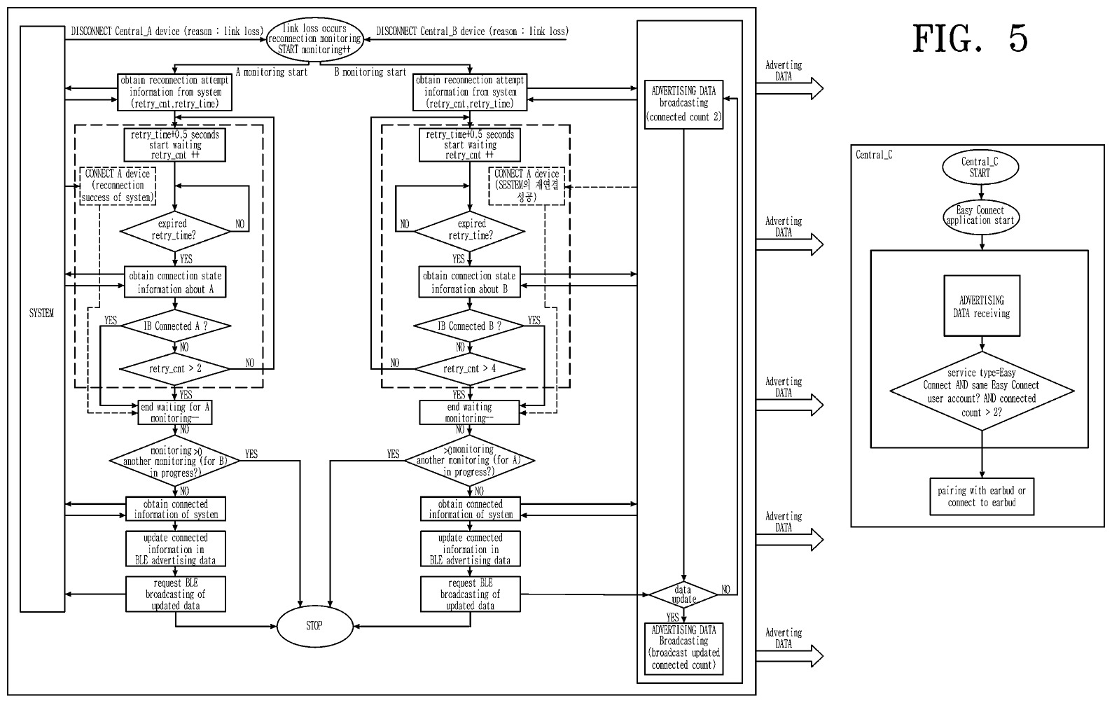

FIG. 5 illustrates the structure of a Bluetooth connection device according to embodiments.

An earbud 20000 in FIG. 5 is a Bluetooth connection device according to embodiments, and may correspond to the device (slave, earphone, headset, or the like) 10000 in FIGS. 1 to 4. Since Bluetooth connection devices according to embodiments may exist in a pair, such as earbuds, each device may include a system 20020.

A device 20010 in FIG. 5 is a third Bluetooth connection device. The device 20010 is the third device described above, and when the Bluetooth connection device 20000 according to embodiments loses a link, it may attempt to connect to a master. The device 20010 may refer to the first to fifth devices, such as those of FIGS. 1 to 4, located around the device 10000.

As illustrated in FIGS. 1 to 5, when link loss occurs in a single-connection state or multi-connection state, the system of the Bluetooth connection device according to embodiments attempts to reconnect for a specific time. The system reports only the link loss to the higher-layer application of the Bluetooth connection device. A method of notifying the application of information indicating a reconnection attempt in progress and/or information indicating a final reconnection failure is provided. Additionally, embodiments provide a method of enabling the application to obtain the knowledge.

A method of monitoring whether a link-lost connection is reconnected to provide information about whether the application of the device according to embodiments is attempting reconnection or whether a final reconnection is failed may be performed.

When the Bluetooth connection device according to embodiments loses a link with device A (e.g., laptop) in the state of multiple connections to device A and device B (e.g., mobile phone), the system of the Bluetooth connection device periodically monitors whether it is reconnected to device A (check whether it is connected to device A), upon receipt of a link loss event.

A monitoring period according to embodiments may be set to match a reconnection period of the system. When a link to device B is also lost while device A is reconnecting, it is monitored whether device B is reconnected, at least longer than the monitoring period of device A. For example, the monitoring period of device B may be twice that of the monitoring period of device A. The reason is that the system attempts to reconnect to device A first and then to device B, rather than it simultaneously attempts to reconnect to device A and device B. Eventually, the application may monitor the states of reconnections of the system to device A and device B, and when connected, BLE-advertise connection state information to adjacent devices.

Therefore, even if single-link/multi-link loss occurs in one or multiple Bluetooth connections in embodiments, the higher-layer application of the Bluetooth device system may monitor a reconnection progress state/final reconnection failure, and thus maintain the number of connected devices while the system is reconnecting. As this information is shared with other devices through BLE advertising, the other devices may avoid making new connections during the reconnection. Accordingly, data communication may be used seamlessly in an original link state used by a user (e.g., earbuds-laptop-mobile phone).

FIG. 5 is a flowchart illustrating a Bluetooth connection operation according to the following embodiments.

1. When the Bluetooth peripheral (slave) 10000 according to embodiments is simultaneously connected to two centrals (masters) 10010, and then link loss 10030 occurs sequentially in the connections, the application of the Bluetooth peripheral checks a reconnection attempt period of the system (host/controller), for reconnection monitoring.

2. When the Bluetooth peripheral (slave) is multi-connected to two centrals (masters), and then link loss sequentially occurs in the connections, the application of the Bluetooth peripheral (slave) monitors reconnection for the link loss of the two connections. The method/device according to embodiments may monitor n reconnections.

3. While monitoring reconnections, the application of the Bluetooth peripheral/slave maintains the number of connected devices until a reconnection failure by including it in the number of reconnected devices, and transmits corresponding information to adjacent devices through BLE advertising. A new connection/reconnection attempt from a third central (master) that receives this information may be blocked. This is because the third device is not a user-desired connection device.

FIG. 5 illustrates an overall process between a Bluetooth connection device (e.g., earbud) and a third device according to embodiments. A detailed flowchart will be described with reference to FIGS. 3 to 5.

Referring to FIG. 5, the Bluetooth connection device may include a receiver receiving multiple audio signals based on multiple links for Bluetooth, and a processor controlling the multiple links. The processor may monitor reconnection of the multiple links based on a reconnection time and a reconnection count, in response to link loss of the multiple links, update information about the number of connections to the multiple links, and advertise the updated information about the number of connections.

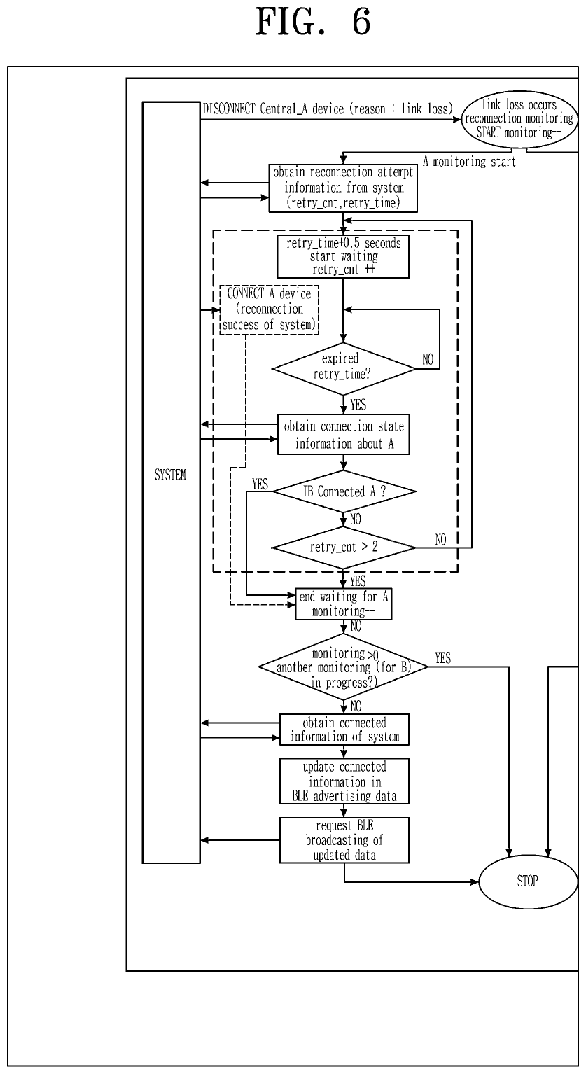

FIG. 6 illustrates a Bluetooth connection method according to embodiments.

FIG. 6 is a flowchart illustrating an operation of reconnecting and monitoring by the Bluetooth connection device 10000 of FIG. 1, when links of the multi-connected devices 10010 are lost.

A Bluetooth connection device according to embodiments may include an application in a higher layer and a system in a lower layer. The system according to embodiments may include a host and/or a controller. The system according to embodiments may correspond to a processor. The Bluetooth connection device according to embodiments may include a processor connected to a memory.

The Bluetooth connection device according to embodiments (shortly referred to as a device according to embodiments or a device) detects link loss while being connected to central A (a first central). When link loss occurs, the device according to embodiments starts the following monitoring process. The monitoring process according to embodiments may be performed at the application level of the Bluetooth connection device according to embodiments.

Information about reconnection attempts is obtained from the system of the device according to embodiments. The reconnection information according to embodiments may include reconnection count information and/or reconnection time information. The reconnection count information and/or the reconnection time information may be a value set by the system.

The reconnection time information may be, for example, 0.5 seconds. The device may wait for as long as the reconnection time information. The number of reconnections may be counted.

The device may identify whether a reconnection time has expired. Upon expiration of the reconnection time, the device may receive connection state information about central A from the system.

The device may identify whether central A is connected. When central A is not connected, the device may identify whether the number of reconnections is greater than a specific value. The specific value according to embodiments may be a value set by the system, and may be, for example, 2. When the number of reconnections is not greater than the specific value, the value of the number of reconnections is increased by 1, and the above-described process is repeated again.

When the number of reconnections is greater than the specific value, the waiting state for central device A is terminated, and the monitoring process is performed.

Further, even when central A is reconnected in the reconnection waiting state, the waiting ends and the monitoring process is performed.

The device may identify whether monitoring information is greater than 0.

When the monitoring information indicates a value greater than 0, it may mean that monitoring of another central B is in progress. When the monitoring information is greater than 0, the device may receive information indicating the number of connected devices from the system.

The device may update the connected information in BLE advertising data.

The device may request to broadcast the updated BLE advertising data.

Referring to FIGS. 5 and 6, multiple links according to embodiments include a first link and a second link. The Bluetooth connection device is connected to a first device via the first link based on Bluetooth, monitors whether the first link is reconnected as many times as a reconnection count during a reconnection time, and update information about the number of devices connected to the first link.

Referring to FIGS. 5 to 7, the multiple links according to embodiments include the first link and the second link. The Bluetooth connection device is connected to a second device via the second link based on Bluetooth, monitors whether the second link is reconnected more times than the reconnection count during the reconnection time, and update information about the number of devices connected to the second link.

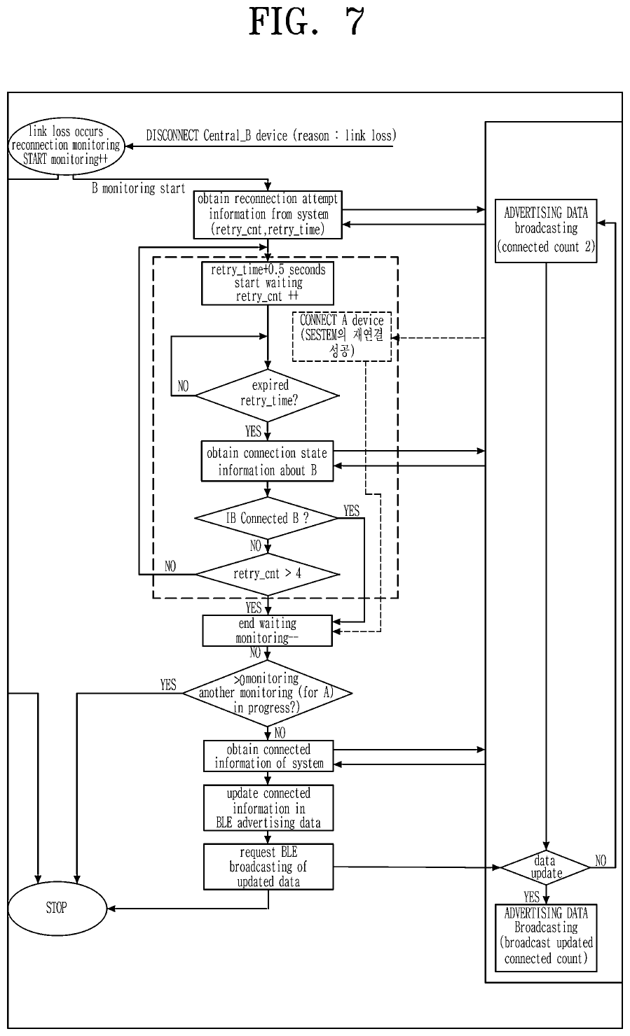

FIG. 7 illustrates a Bluetooth connection method according to embodiments.

FIG. 7 illustrates a process of performing a Bluetooth connection method as in FIG. 6. However, since a device is multi-connected, FIG. 7 illustrates a process of monitoring and controlling link loss for central B, which is connected in addition to the connection in FIG. 6. The basic process is identical/similar to FIG. 6.

The Bluetooth connection device according to embodiments (shortly referred to as a device according to embodiments or a device) detects link loss while connected to central B (a second central). When link loss occurs, the device according to embodiments starts the following monitoring process. The monitoring process according to embodiments may be performed at the application level of the Bluetooth connection device according to embodiments.

Reconnection attempt information is obtained from the system of the device according to embodiments. The reconnection information according to embodiments may include reconnection count information and/or reconnection time information. The reconnection count information and/or the reconnection time information may be values set by the system.

The reconnection time information may be, for example, 0.5 seconds. The device may wait for as long as the reconnection time information, and count the number of reconnections.

The device may identify whether the reconnection time has expired. Upon expiration of the reconnection time, the device may receive connection state information about central B from the system.

The device may identify whether central B is connected. When central B is not connected, the device may identify whether the number of reconnections is greater than a specific value. The specific value according to embodiments is a value set by the system and may be, for example, 4. If the number of reconnections is not greater than the specific value, the value of the number of reconnections is increased by 1, and the above-described process is repeated again.

When the number of reconnections is greater than the specific value, the waiting state for central B is terminated, and the monitoring process is performed.

Additionally, even if central N is reconnected in the reconnection waiting state, the waiting process is terminated, and the monitoring process is performed.

The device may identify whether monitoring information is greater than 0. When the monitoring information indicates a value greater than 0, it may mean that monitoring of another central A is in progress. When the monitoring information is greater than 0, the device may receive information indicating the number of connected devices from the system.

The device may update the connected information in BLE advertising data.

The device may request to broadcast the updated BLE advertising data.

The system according to embodiments may broadcast the advertising data. The advertising data may include information about the number of devices connected to the device. For example, when the device is connected to a laptop and a mobile phone, the number of connected devices is 2.

When the number of devices connected to the device changes after link loss and reconnection/monitoring according to embodiments is performed, the data may be updated. The device may broadcast the updated number of connected devices.

Referring to FIG. 7, multiple links according to embodiments may include a first link and a second link. The Bluetooth connection device may be connected to a second device via the second link based on Bluetooth, monitor whether the second link is reconnected more times than a reconnection count during a reconnection time in response to link loss of the second link, and update information about the number of devices connected to the second link.

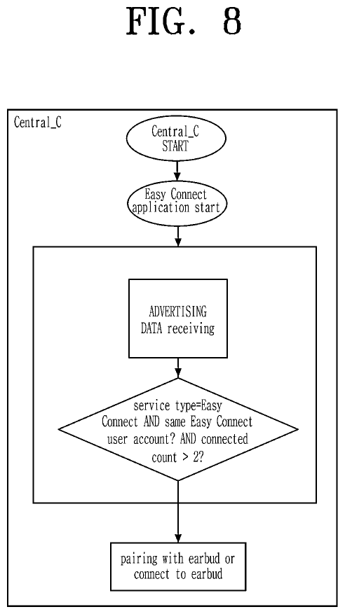

FIG. 8 illustrates a central device for a Bluetooth connection device according to embodiments.

FIG. 8 illustrates an additional third device 20010 separate from devices 10010 to which the Bluetooth connection device 10000 of FIG. 1 is multi-connected. The third device 20010 may be referred to as central C. In the Bluetooth connection method according to embodiments, it is a third device related to whether or not to intervene in a connection during the reconnection/monitoring/advertising process.

The Bluetooth connection device according to embodiments may broadcast advertising data to central C. Central C may be any of a plurality of devices located around the Bluetooth connection device.

Central C may make the following decisions based on the Bluetooth connection method according to embodiments.

The device transmits advertising data to central C.

Central C identifies whether a service type is Easy Connect and whether it is the same Easy Connect user account. Then, central C determines whether the number of devices connected to the network is less than a specific value. The specific value according to embodiments may indicate the number of devices connected to the network. For example, when a Bluetooth device is connected to two devices, it may be identified whether the number of connected devices is less than two. When it is less than two, the third device may additionally intervene and connect to the Bluetooth connection device. The Bluetooth connection device may be paired with central C.

Referring to FIG. 8, when the number of connected devices indicated by updated information is equal to or greater than a specific value based on the updated information according to embodiments, an additional device may not be connected to multiple links.

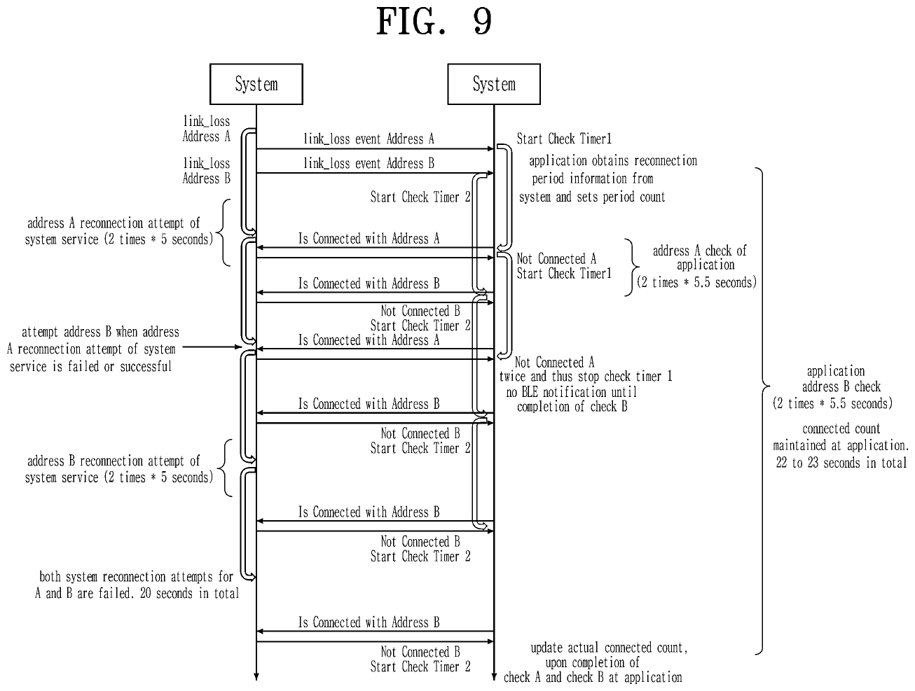

FIG. 9 illustrates link loss of multiple connections according to embodiments.

FIG. 9 is a detailed diagram illustrating the process described with reference to FIGS. 5 to 8. In other words, FIG. 9 illustrates a Bluetooth connection method when all multiple connections illustrated in FIG. 1 are lost.

When a Bluetooth connection device (including a system with a host and a controller, and an application) is multi-connected and then loses the multiple connections, it may attempt reconnections sequentially or simultaneously.

The application of the Bluetooth connection device is connected to the system and may identify the multiple connections and disconnections. The application is notified of disconnections caused by simultaneous multi-link loss after the multiple connections and is not aware whether reconnection is failed. When the reconnection is successful, the application is notified of the success again.

The process performed by the Bluetooth connection device according to the embodiments will be described below, separately at a system level and an application level.

The system detects occurrence of link loss for address A. An event of link loss of address A is notified to the application.

The application activates a timer (a first time). The application may receive reconnection period information from the system. The application may set a period count.

The system detects occurrence of link loss for address B. An event of link loss for address B is notified to the application.

The application activates a timer (a second time).

The system may attempt to reconnect to address A a specific number of times for a specific time. For example, reconnection may be attempted twice for 5 seconds.

When connected to address A, the application and the system may notify each other of the connection.

The application may attempt to reconnect to address A a specific number of times for a specific time. For example, reconnection may be attempted twice for 5.5 seconds.

When address A is not connected, the application activates the timer (the first time).

When connected to address B, the application and the system may notify each other of the connection.

When not connected to address B, the application activates the timer (the second time).

The system attempts to reconnect to address B when reconnection to address A is failed or successful.

When not connected to address A, the application waits until the second time expires and does not perform an advertising notification, because it has attempted reconnection twice.

The application may reconnect to address B four times for 5.5 seconds.

The system may reconnect to address B twice for 5 seconds.

Each of the system and the application may monitor reconnection to addresses A and B a specific number of times for a specific time, determines a final number of connected devices, and updates the number of connected devices.

Referring to FIG. 6, multiple links according to embodiments may include a first link and a second link, link loss may occur in at least one of the first link or the second link, and the at least one link to which the link loss occurs may be reconnected by monitoring.

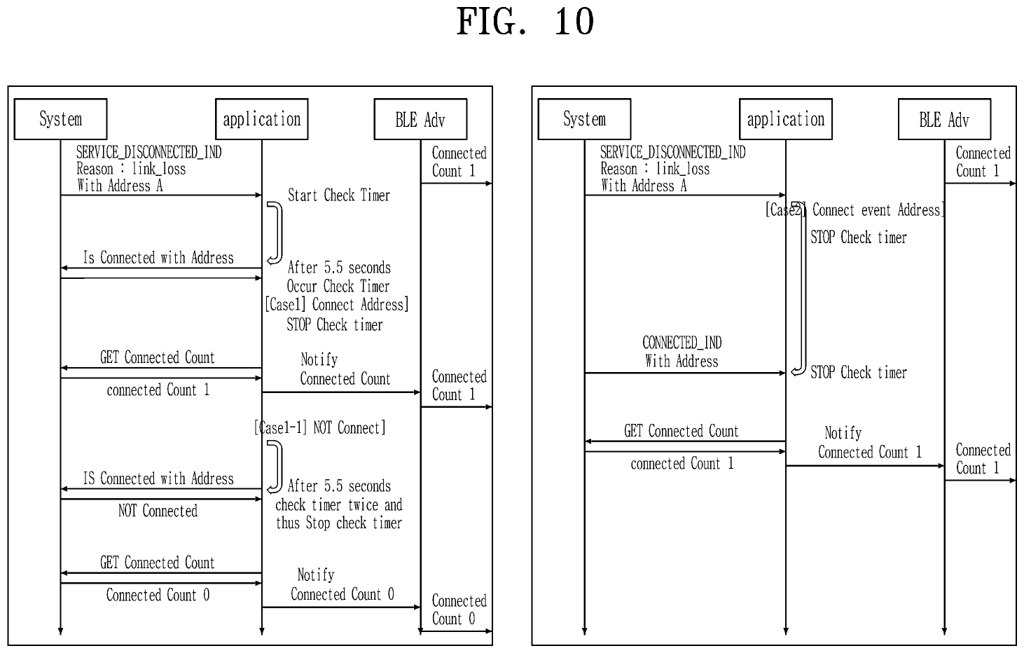

FIG. 10 illustrates single-link loss according to embodiments.

FIG. 10 is a detailed diagram illustrating the process described with reference to FIGS. 5 to 8. In other words, FIG. 10 illustrates a Bluetooth connection method in the case of loss of one of the multiple connections of FIG. 1.

To maintain the number of connected devices when link loss occurs, a timer may be monitored a specific number of times (e.g., twice) for a specific time (e.g., 5.5 seconds). The application may maintain a connection for a specific time. For example, the application may update the number of Bluetooth connection devices after waiting for 11 seconds.

Case 1 in FIG. 10: A check timer is activated once, it is identified whether a lost link is reconnected, and the timer ends upon reconnection. For example, the timer monitors reconnection of a single lost link for 5.5 seconds and, when the link is connected, the number of connected devices is notified as 1.

Case 1-1 in FIG. 10: A check timer is activated once, and when reconnection to a lost link is failed, the check timer is activated at a second time. When the timer lasts 5.5 seconds each time and is activated twice, the monitoring mode is maintained for 11 seconds, and a final number of connected devices is notified as 1.

Case 2 in FIG. 10: When reconnection is successful for 5.5 seconds of the timer, the timer is terminated because a connection event for link loss has occurred. For example, after the connection is maintained for 5 seconds, the number of connected devices is notified as 1.

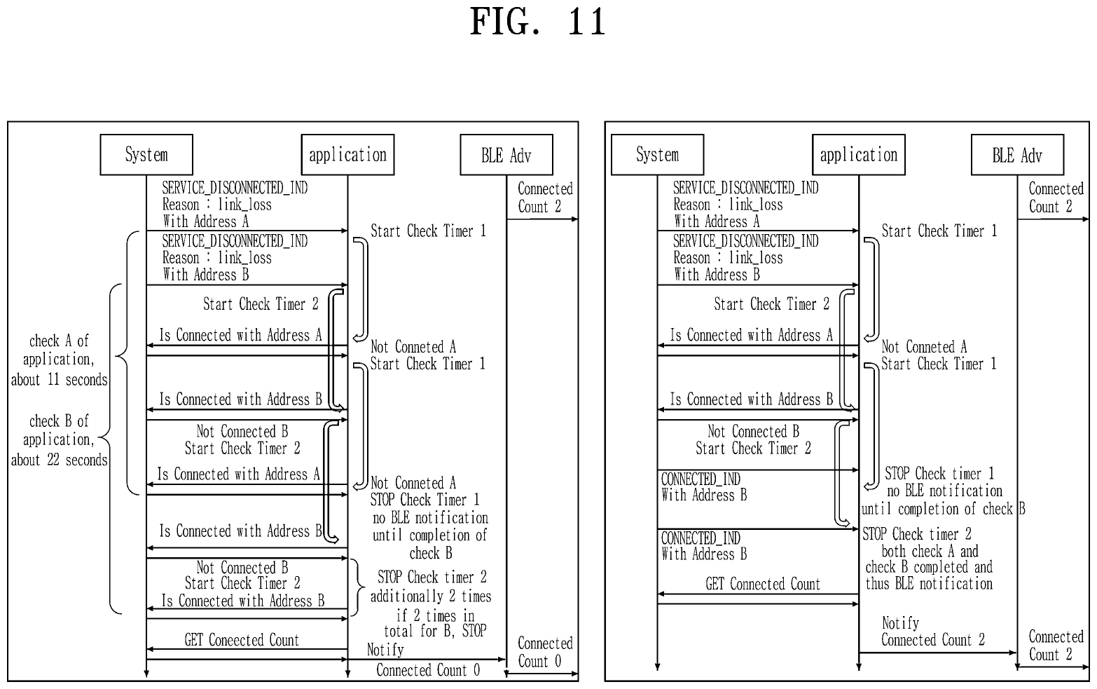

FIG. 11 illustrates multiple connections according to embodiments.

FIG. 11 is a detailed diagram illustrating the process described with reference to FIGS. 5 to 8. In other words, FIG. 11 illustrates a Bluetooth connection method when all multiple connections illustrated in FIG. 1 are lost. Further, FIG. 11 is a flowchart when all final reconnections are failed or successful after monitoring.

Case 3 in FIG. 11: All of reconnections to connections A and B may be eventually failed. For example, connection A may be monitored 2 times for 5.5 seconds each for 11 seconds, and connection B may be monitored 4 times for 5.5 seconds each for 22 seconds. When a total monitoring period is approximately 23 seconds due to each timer running for multi-link loss, the final number of connected devices may be updated and notified as 0 due to all reconnection failures.

Case 4 in FIG. 11: Final reconnections to connections A and B may be successful. The final number of connected devices may be updated and notified as 2.

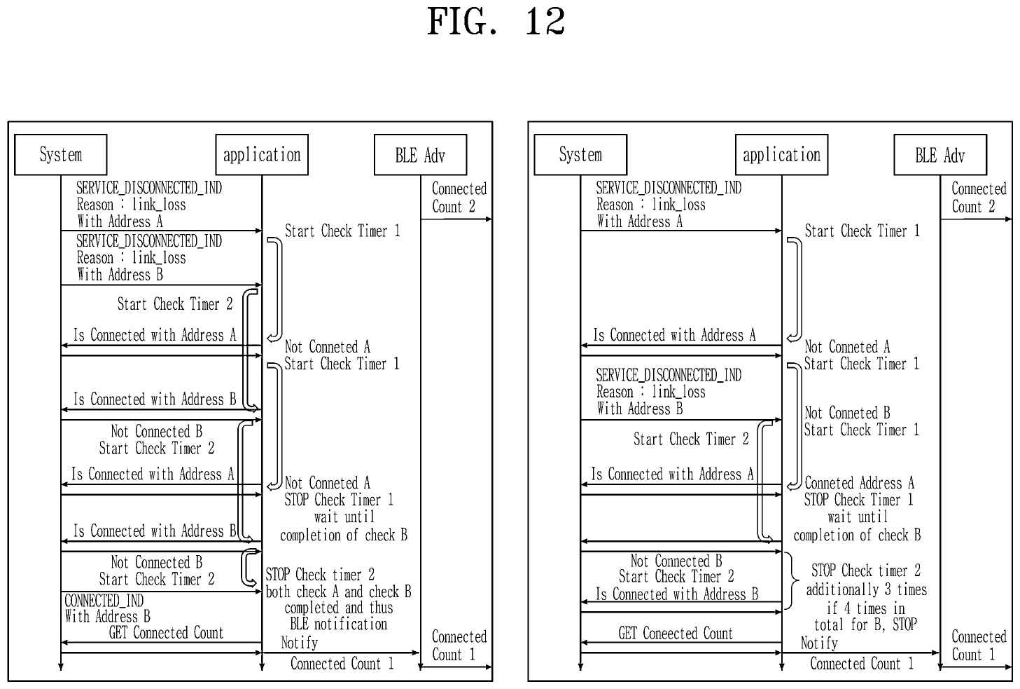

FIG. 12 illustrates multiple connections according to embodiments.

FIG. 12 is a flowchart when only some of final reconnections are successful after monitoring, in addition to the embodiments described with reference to FIG. 11.

Case 5 in FIG. 12: When both connections A and B are lost, and only connection B is reconnected in a monitoring process, the final number of connected devices may be notified as 1.

Case 6 in FIG. 12: When both connections A and B are lost and only connection A is reconnected in a monitoring process, the final number of connected devices may be notified as 1.

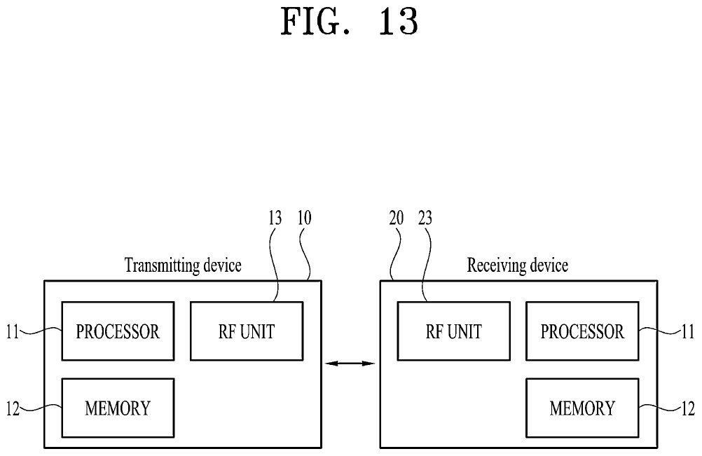

FIG. 13 illustrates a Bluetooth connection device according to embodiments.

FIG. 13 illustrates an exemplary structure of the Bluetooth connection device described in FIG. 1. The Bluetooth connection device described in FIG. 1 may include a system level including a host and a controller, and a higher application level. Further, as illustrated in FIG. 13, they may correspond to a transmitting device 10 and a receiving device 20, respectively. The system may be a transmitting device or a receiving device.

The transmitting device 10 and the receiving device 20 include radio frequency (RF) devices 13 and 23 for transmitting or receiving wireless signals including information and/or data, memories 12 and 22 for storing signals, messages, and various information related to communication in a wireless communication system, and processors 11 and 21. The processors 11 and 21 are operatively coupled to components including the RF devices 13 and 23 and the memories 12 and 22 and configured to control the memories 12 and 22 and/or the RF devices 13 and 23, respectively.

The memories 12 and 22 may store programs for processing and control in the processors 11 and 21, and temporarily store input and output signals. The memories 12 and 22 may be used as buffers.

The processors 11 and 21 provide overall control to operations of various modules of the transmitting device and the receiving device. In particular, the processors 11 and 21 may perform various control functions to perform embodiments. The processors 11 and 21 may be referred to as controllers, microcontrollers, microprocessors, microcomputers, and so on. The processors 11 and 21 may be implemented in various manners, such as hardware, firmware, software, or a combination thereof. In the case of implementing the embodiments in hardware, there may be application-specific integrated circuits (ASICs), digital signal processors (DSPs), digital signal processing devices (DSPDs), programmable logic devices (PLDs), or field programmable gate arrays (FPGAs), which are configured to implement the embodiments. They are included in the processors 11 and 21. When operations or functions according to embodiments are implemented in firmware or software, the firmware or software may be configured to include modules, procedures, functions, and so on for performing the implemented functions or operations of the embodiments. The firmware or software configured to implement the embodiments may be included in the processors 11 and 21 or stored in the memories 12 and 22 for execution by the processors 11 and 21.

The processor 11 of the transmitting device 10 encodes and modules a signal and/or data scheduled for transmission to an external device by the processor 11 or a scheduler connected to the processor 11, and transmits the signal and/or the data to the RF device 13. For example, the processor 11 converts a data stream to K layers through demultiplexing, channel coding, scrambling, and modulation. The coded data stream is called a codeword and equivalent to a transport block (TB), which is a data block provided by the media access control (MAC) layer. One TB is encoded into one codeword, and each codeword is transmitted to a receiver in the form of one or more layers. An oscillator may be included in the RF device 13, for frequency upconversion. The RF device 13 may include Nt (Nt is a positive integer) transmission antennas.

The signal process of the transmitting device 10 is performed reversely in the receiving device 20. The RF device 23 of the receiving device 20 receives a wireless signal transmitted by the transmitting device 10 under the control of the processor 21. The RF device 23 may include Nr (Nr is a positive integer) reception antennas. The RF device 23 downconverts the frequency of a signal received through each reception antenna and restores a baseband signal. The RF device 23 may include an oscillator for frequency downconversion. The processor 21 may restore original data transmitted by the transmitting device 10 by decoding and demodulating the wireless signal received through the reception antenna.

Each of the RF devices 13 and 23 includes at least one antenna. The antenna serves to transmit a signal processed by the RF device 13 or 23 to an external device or receive a wireless signal from an external device. According to an implementation of the embodiments, the antenna transmits a wireless signal to the RF device 13 or 23 controlled by the processor 11 or 21. An antenna is also called an antenna port. Each antenna may be configured as one physical antenna or a combination of two or more physical antenna elements. A signal transmitted by each antenna is not decomposed by the receiving device 20. A reference signal (RS) transmitted in correspondence with the antenna defines an antenna from the perspective of the receiving device 20, and allows the receiving device 20 to perform channel estimation on the antenna, regardless of whether the channel is a single radio channel of a single physical antenna or a composite channel of a PL. Antennas are defined to be derived from channels that carry different symbols through the same antenna. For an RF device that supports multiple-input, multiple-output (MIMO) using multiple antennas to transmit and receive data, two or more antennas may be connected to the RF device.

A UE operates as the transmitting device 10 on uplink and as the receiving device 20 on downlink. In an implementation of embodiments, an eNB operates as the receiving device 20 on UL and as the transmitting device 10 on DL. A processor, an RF device, and a memory included in the UE are respectively referred to as a UE processor, a UE RF device, and a UE memory, and a processor, an RF device, and a memory included in the eNB are respectively referred to as an eNB processor, an eNB RF device, and an eNB memory.

A Bluetooth connection method according to embodiments performed by a Bluetooth connection device according to embodiments may include receiving multiple audio signals based on multiple links for Bluetooth, and controlling the multiple links. The controlling may include, in response to link loss of the multiple links, monitoring reconnection of the multiple links based on a reconnection time and a reconnection count, updating information about the number of connections to the multiple links, and advertising the updated information about the number of connections.

Accordingly, in embodiments, an application at a higher layer of a Bluetooth device system may monitor a reconnection progress state/reconnection final failure, in spite of occurrence of single-link/multi-link loss in one or multiple Bluetooth connections. The system may maintain the number of connected devices during reconnection. As this information is shared with other devices through BLE advertising, the other devices may avoid making new connections during the reconnection.

The embodiments have been described in terms of a method and/or an apparatus, and the description of the method and the description of the apparatus may be applied to complement each other.

For convenience of explanation, each drawing has been described separately, but it is also possible to design a new embodiment by merging the embodiments described in each drawing. In addition, according to the needs of those skilled in the art, designing a computer-readable recording medium recording a program for executing the foregoing embodiments also falls within the scope of the embodiments. The apparatus and method according to the embodiments are not limited to the configurations and methods of the embodiments described above, but all or part of the embodiments may be selectively combined so that various modifications can be made. Although preferred embodiments of the embodiments have been shown and described, the embodiments are not limited to the specific embodiments described above, and may be used in the technical field to which the embodiments pertain without departing from the subject matter of the embodiments claimed in the claims. Obviously, various modifications can be made by those skilled in the art, and these modifications should not be understood individually from the technical ideas or perspectives of the embodiments.

Various components of a device according to embodiments may be implemented in hardware, software, firmware, or a combination thereof. Various components of the embodiments may be implemented as a single chip, for example, one hardware circuit. According to embodiments, components according to the embodiments may be implemented as separate chips. According to embodiments, at least one of components of the device according to embodiments may include at least one processor capable of executing at least one program, and the at least one program may execute or include instructions for executing at least one of operations/methods according to embodiments. The executable instructions for performing the methods/operations of the device according to embodiments may be stored in a non-transitory CRM or other computer program products configured to be executed by the at least one processor, or may be stored in a transitory CRM or other computer program products configured to be executed by the at least one processor. Additionally, memory according to embodiments may be used to conceptually include not only volatile memory (e.g., RAM, etc.) but also non-volatile memory, flash memory, and PROM. Additionally, it may also be implemented in the form of carrier waves, such as transmission over the Internet. Additionally, a processor-readable recording medium may be distributed in a computer system connected to a network, so that a processor-readable code may be stored and executed in a distributed manner.

In this document, “/” and “,” are interpreted as “and/or,” For example. “A/B” is interpreted as “A and/or B”, and “A, B” is interpreted as “A and/or B”. Additionally, “A/B/C” means “at least one of A, B and/or C.” Additionally, “A, B, C” also means “at least one of A. B and/or C.” Additionally, in this document, “or” is interpreted as “and/or.” For example, “A or B” may mean 1) only “A”, 2) only “B”, or 3) “A and B”. In other words, “or” in this document may mean “additionally or alternatively.”

Terms such as first, second, and so on may be used to describe various components of embodiments. However, the interpretation of various components according to embodiments should not be limited by the above terms. These terms are merely used to distinguish one component from another. For example, a first user input signal may be referred to as a second user input signal. Similarly, the second user input signal may be referred to as the first user input signal. Use of these terms should be interpreted without departing from the scope of various embodiments. Although the first user input signal and the second user input signal are both user input signals, they do not mean the same user input signals unless clearly indicated in the context.

Terms used to describe embodiments are for the purpose of describing specific embodiments, and are not intended to limit the embodiments. As used in the description of the embodiments and the claims, a singular form is intended to include plural referents unless the context clearly dictates otherwise. The expression and/or is used in a sense that includes all possible combinations between the terms. The expression describes the presence of features, numbers, steps, elements, and/or components, and does not imply the absence of additional features, numbers, steps, elements, and/or components. Conditional expressions such as when, when, and so on used to describe embodiments are not limited to optional cases. It is intended that when a specific condition is satisfied, a relevant operation is performed or a relevant definition is interpreted in response to the specific condition.

Additionally, operations according to embodiments described in this document may be performed by a transmitting and receiving device including a memory and/or a processor according to embodiments. The memory may store programs for processing/controlling operations according to embodiments, and the processor may control various operations described in this document. A processor may be referred to as a controller or the like. In embodiments, operations may be performed by firmware, software, and/or a combination thereof, and the firmware, software, and/or combination thereof may be stored in the processor or the memory.

Meanwhile, operations according to the above-described embodiments may be performed by a transmitting device and/or a receiving device according to embodiments. The transmitting device and/or the receiving device may include a transceiver that transmits and receives media data, a memory that stores instructions (program code, algorithm, flowchart and/or data) for a process according to embodiments, and a processor that controls the operations of the transmitting device and/or the receiving device.

A processor may be referred to as a controller or the like, and correspond to, for example, hardware, software, and/or a combination thereof. Operations according to the above-described embodiments may be performed by the processor. Additionally, the processor may be implemented as an encoder/decoder or the like, for the operations of the above-described embodiments.

### MODE FOR CARRYING OUT THE INVENTION

As described above, relevant content has been described in the best mode for carrying out the invention.

### INDUSTRIAL APPLICABILITY

As described above, the embodiments are applicable wholly or partially to a Bluetooth connection device and system.

Those skilled in the art may change or modify the embodiments within the scope of the embodiments.

The embodiments may include changes/modifications, and the changes/modifications do not depart from the scope of the claims and their equivalents.

1. A Bluetooth connection device comprising:
a receiver receiving multiple audio signals based on multiple links for Bluetooth; and
a processor controlling the multiple links,
wherein the processor is configured to:
in response to link loss of the multiple links, monitor reconnection of the multiple links based on a reconnection time and a reconnection count,
update information about the number of connections to the multiple links; and
advertise the updated information about the number of connections.

2. The Bluetooth connection device of claim 1, wherein the multiple links include a first link and a second link, and
wherein the Bluetooth connection device is connected to a first device via the first link based on Bluetooth, monitors whether the first link is reconnected as many times as the reconnection count during the reconnection time, in response to link loss of the first link, and updates information about the number of devices connected to the first link.

3. The Bluetooth connection device of claim 1, wherein the multiple links include a first link and a second link, and
wherein the Bluetooth connection device is connected to a second device via the second link based on Bluetooth, monitors whether the second link is reconnected more times than the reconnection count during the reconnection time, in response to link loss of the second link, and updates information about the number of devices connected to the second link.

4. The Bluetooth connection device of claim 2, wherein when the number of connected devices indicated by the updated information is equal to or greater than a specific value based on the updated information, an additional device is not allowed to be connected to the multiple links.

5. The Bluetooth connection device of claim 1, wherein the multiple links include a first link and a second link,
wherein link loss occurs in at least one of the first link or the second link, and
wherein the at least one link to which the link loss occurs is reconnected by monitoring.

6. A Bluetooth connection method comprising:
receiving multiple audio signals based on multiple links for Bluetooth; and
controlling the multiple links,
wherein the controlling comprises:
in response to link loss of the multiple links, monitoring reconnection of the multiple links based on a reconnection time and a reconnection count,
updating information about the number of connections to the multiple links; and
advertising the updated information about the number of connections.

7. The Bluetooth connection method of claim 6, wherein the multiple links include a first link and a second link, and
wherein the Bluetooth connection device is connected to a first device via the first link based on Bluetooth, monitors whether the first link is reconnected as many times as the reconnection count during the reconnection time, in response to link loss of the first link, and updates information about the number of devices connected to the first link.

8. The Bluetooth connection method of claim 6, wherein the multiple links include a first link and a second link, and
wherein the Bluetooth connection device is connected to a second device via the second link based on Bluetooth, monitors whether the second link is reconnected more times than the reconnection count during the reconnection time, in response to link loss of the second link, and updates information about the number of devices connected to the second link.

9. The Bluetooth connection method of claim 7, wherein when the number of connected devices indicated by the updated information is equal to or greater than a specific value based on the updated information, an additional device is not allowed to be connected to the multiple links.

10. The Bluetooth connection method of claim 6, wherein the multiple links include a first link and a second link,
wherein link loss occurs in at least one of the first link or the second link, and
wherein the at least one link to which the link loss occurs is reconnected by monitoring.
